(19) United States
(12) Patent Application Publication
(10) Pub. No.: US 2024/0141935 A1
(43) Pub. Date: May 2, 2024

(54) FASTENER STRUCTURE

(71) Applicant: DTECH PRECISION INDUSTRIES CO., LTD., New Taipei City (TW)

(72) Inventor: TING-JUI WANG, New Taipei City (TW)

(21) Appl. No.: 18/496,950

(22) Filed: Oct. 30, 2023

Related U.S. Application Data
(62) Division of application No. 17/975,627, filed on Oct. 28, 2022.

(51) Int. Cl. F16B 5/06; F16B 5/08

(52) U.S. Cl. CPC F16B 5/065; F16B 5/08

(57) ABSTRACT

A fastener structure used to arrange a second object on a first object and a method of use of the fastener structure includes an engaging portion, a direction limiting portion, and an assembly portion. The engaging portion is for engaging to a second object. The direction limiting portion is connected to the engaging portion and is for limiting a movement direction of the second object engaged with the engaging portion. The assembly portion is for assembling to the first object.

### CROSS-REFERENCE TO RELATED APPLICATION

This application is a divisional patent application of U.S. application Ser. No. 17/975,627 filed on Oct. 28, 2022, the entire contents of which are hereby incorporated by reference for which priority is claimed under 35 U.S.C. § 121.

### BACKGROUND OF THE INVENTION

### 1. Field of the Invention

The present disclosure provides a fastener structure and a method of use and an assembly method thereof, and in particular to a fastener structure for arranging an object on another object and a method of use and an assembly method thereof.

### 2. Description of the Related Art

A fixing component is conventionally used to connect two parallel plates. The fixing component is usually implemented by a screw locking technique, and a specific implementation form thereof includes a screw and a sleeve to form a fixing member. One end of the screw has a force receiving portion that is provided with a screwdriver slot, and the other end has a screw rod connected to the force receiving portion. The sleeve is sleeved at the screw rod of the screw to allow the screw to move in the sleeve. Thus, the fixing member can be coupled to a first object (for example, a circuit board) using one end of the sleeve, and the screw rod of the screw can pass through one end of the sleeve and correspond to a lock hole of a second object (for example, a frame or a housing). A tool is then used to apply an external rotational force on the screwdriver slot of the force receiving portion of the screw, so as to lock the screw rod in the lock hole of the second object, thereby completing a combined structure of the first object and the second object that are connected and arranged in parallel.

However, the conventional connection method above involves a tool, resulting in complicated and time-consuming assembly and removal processes.

### BRIEF SUMMARY OF THE INVENTION

With extensive research and development, the inventor provides a fastener structure and a method of use and an assembly method thereof in the aim of achieving the objective of quickly and simply arranging a second object on a first object.

A fastener structure for arranging a second object on a first object is provided according to an embodiment of the present disclosure. The fastener structure includes an engaging portion, a direction limiting portion, and an assembly portion. The engaging portion is for engaging the second object. The direction limiting portion is connected to the engaging portion and is for limiting a movement direction of the second object engaged with the engaging portion. The assembly portion is for assembling on the first object.

A fastener structure for arranging a second object on a first object is provided according to an embodiment of the present disclosure. The fastener structure includes the foregoing engaging portion, the foregoing direction limiting portion and an anti-rotation portion. The anti-rotation portion is for preventing the fastener structure from rotating relative to the first object.

A fastener structure is provided according to an embodiment of the present disclosure. The fastener structure includes the foregoing anti-rotation portion and the foregoing assembly portion. The assembly portion is an engaging portion, a rivet connection portion, an expansion connection portion, a weld connection portion, a lock connection portion, or an elastic fastening portion.

A method of use of a fastener structure is provided according to an embodiment of the present disclosure, and the method uses the fastener structure of the aforementioned embodiments to arrange a second object on a first object. The method includes assembling the fastener structure on the first object, simultaneously generating an anti-rotation effect between the anti-rotation portion and the first object, and fitting the second object in a direction defined or limited by the direction limiting portion into the engaging portion.

A method of use of a fastener structure is provided according to an embodiment of the present disclosure, and the method uses the fastener structure of the aforementioned embodiments to arrange a second object on a first object. The method includes assembling the assembly portion at the first object, simultaneously generating an anti-rotation effect between the anti-rotation portion and the first object, and fitting the second object in a direction defined or limited by the direction limiting portion into the engaging portion.

A method of use of a fastener structure is provided according to an embodiment of the present disclosure, and uses the fastener structure of the aforementioned embodiments to arrange a second object on a first object. The method includes assembling the fastener structure on the first object, and fitting the second object in a direction defined or limited by the direction limiting portion into the engaging portion.

An assembly method of a fastener structure is provided according to an embodiment of the present disclosure, and is for assembling the foregoing fastener structure on a first object, wherein the fastener structure is adapted to be placed in a carrier. The assembly method includes: providing a tool to pick up the fastener structure from the carrier; moving the fastener structure by the tool to a predetermined height above an assembly position of the first object; releasing or setting free the fastener structure from the tool, so that the fastener structure drops and becomes placed at the assembly position of the first object. Alternatively, the method includes: providing a tool to pick up the fastener structure from the carrier; pressing or elastically pressing the fastener structure downward toward the first object; and releasing or setting free the fastener structure by the tool, so that the fastener structure becomes placed at the assembly position. Alternatively, the method includes: providing a tool to pick up the fastener structure from the carrier; and releasing or setting free the fastener structure by the tool, so that the fastener structure becomes placed at the assembly position.

Thus, the fastener structure and the method of use and the assembly method thereof of the present disclosure are capable of quickly and simply arranging a second object on a first object and removing the second object from the first object in a predetermined direction.

### BRIEF DESCRIPTION OF THE DRAWINGS

FIG. 1 is a first perspective schematic diagram of a fastener structure according to an embodiment of the present disclosure.

FIG. 2 is a cross-sectional schematic diagram of the fastener structure in FIG. 1.

FIG. 3 is a first perspective schematic diagram of applying a fastener structure to arrange a second object on a first object according to an embodiment of the present disclosure.

FIG. 4 is a first cross-sectional schematic diagram of operation of applying a fastener structure to arrange a second object on a first object according to an embodiment of the present disclosure.

FIG. 5 is a second perspective schematic diagram of a fastener structure according to an embodiment of the present disclosure.

FIG. 6 is a side schematic diagram of the fastener structure in FIG. 5.

FIG. 7A is a respective side schematic diagram of a fastener structure according to embodiments of the present disclosure.

FIG. 7B is a respective side schematic diagram of a fastener structure according to embodiments of the present disclosure.

FIG. 7C is a respective side schematic diagram of a fastener structure according to embodiments of the present disclosure.

FIG. 7D is a respective side schematic diagram of a fastener structure according to embodiments of the present disclosure.

FIG. 8 is a third perspective schematic diagram of a fastener structure according to an embodiment of the present disclosure.

FIG. 9 is a side schematic diagram of the fastener structure in FIG. 8.

FIG. 10 is a second perspective schematic diagram of applying a fastener structure to arrange a second object on a first object according to an embodiment of the present disclosure.

FIG. 11 is a second cross-sectional schematic diagram of operation of applying a fastener structure to arrange a second object on a first object according to an embodiment of the present disclosure.

FIG. 12 is a flowchart of assembling a fastener structure to a first object according to an embodiment of the present disclosure.

FIG. 13 is a first cross-sectional schematic diagram of assembling a fastener structure to a first object according to an embodiment of the present disclosure.

FIG. 14 is a top schematic diagram corresponding to FIG. 13.

FIG. 15 is a second cross-sectional schematic diagram of assembling a fastener structure to a first object according to an embodiment of the present disclosure.

FIG. 16 is a third cross-sectional schematic diagram of assembling a fastener structure to a first object according to an embodiment of the present disclosure.

FIG. 17A is a fourth perspective schematic diagram of a fastener structure according to an embodiment of the present disclosure.

FIG. 17B is a side schematic diagram of the fastener structure in FIG. 17A.

FIG. 18 is a first top schematic diagram of a direction limiting portion relative to an assembly portion of a fastener structure according to an embodiment of the present disclosure.

FIG. 19 is a second top schematic diagram of a direction limiting portion relative to an assembly portion of a fastener structure according to an embodiment of the present disclosure.

FIG. 20 is a third top schematic diagram of a direction limiting portion relative to an assembly portion of a fastener structure according to an embodiment of the present disclosure.

FIG. 21 is a fourth top schematic diagram of a direction limiting portion relative to an assembly portion of a fastener structure according to an embodiment of the present disclosure.

FIG. 22 is a first schematic diagram of an assembly method of a fastener structure according to an embodiment of the present disclosure.

FIG. 23 is a second schematic diagram of an assembly method of a fastener structure according to an embodiment of the present disclosure.

FIG. 24 is a fifth perspective schematic diagram of a fastener structure according to an embodiment of the present disclosure.

FIG. 25 is a schematic diagram of the fastener structure in FIG. 24 correspondingly expansion connected in an anti-rotation manner to a first object according to an embodiment of the present disclosure.

FIG. 26 is a cross-sectional schematic diagram of a fastener structure according to an embodiment of the present disclosure.

FIG. 27 is a cross-sectional schematic diagram of a fastener structure according to an embodiment of the present disclosure.

FIG. 28 is a cross-sectional schematic diagram of a fastener structure according to an embodiment of the present disclosure.

FIG. 29 is a cross-sectional schematic diagram of a fastener structure according to an embodiment of the present disclosure.

FIG. 30 is a sectional operation schematic diagram of a fastener structure according to an embodiment of the present disclosure.

FIG. 31 is a partial perspective schematic diagram of a fastener structure that engages a second object with a first object according to an embodiment of the present disclosure.

FIG. 32 is a top schematic diagram of a fastener structure according to an embodiment of the present disclosure.

FIG. 33 is a cross-sectional schematic diagram of FIG. 32.

### DETAILED DESCRIPTION OF THE INVENTION

Aspects of the present disclosure are provided below.

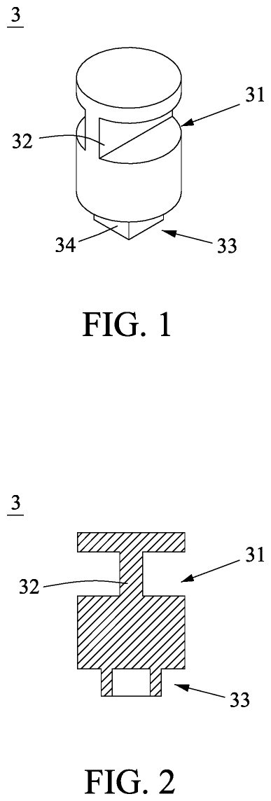

Referring to FIG. 1 to FIG. 4, a fastener structure 3 for connecting a second object 2 to a first object 1 is provided according to an embodiment of the present invention. The fastener structure 3 includes an engaging portion 31, a direction limiting portion 32 and an assembly portion 33. The engaging portion 31 is for engaging the second object 2. The direction limiting portion 32 is connected to the engaging portion 31 and is for limiting a movement direction of the second object 2 engaged with the engaging portion 31. The assembly portion 33 is for assembling to the first object 1.

The fastener structure 3 may be made by means of manufacturing methods such as milling molding, NC molding, CNC molding, plastic injection molding, plastic embedding and injection molding, metal injection molding, forging molding, or roll molding.

A fastener structure 3 is provided according to an embodiment of the present invention. The fastener structure 3 includes the engaging portion 31, the direction limiting portion 32 and an anti-rotation portion 34. The anti-rotation portion 34 is connected to the assembly portion 33 and is for preventing the fastener structure 3 from rotating relative to the first object 1.

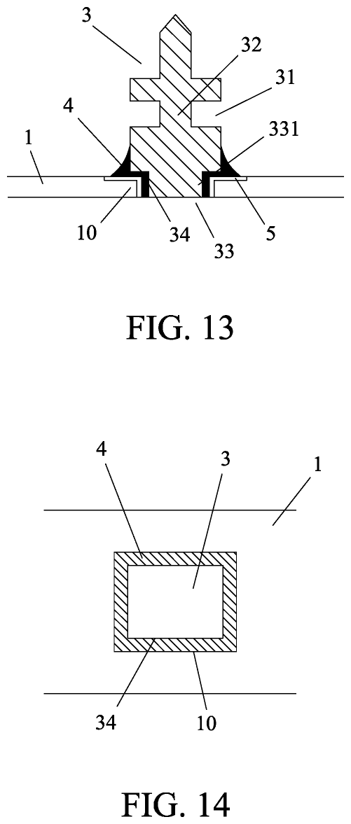

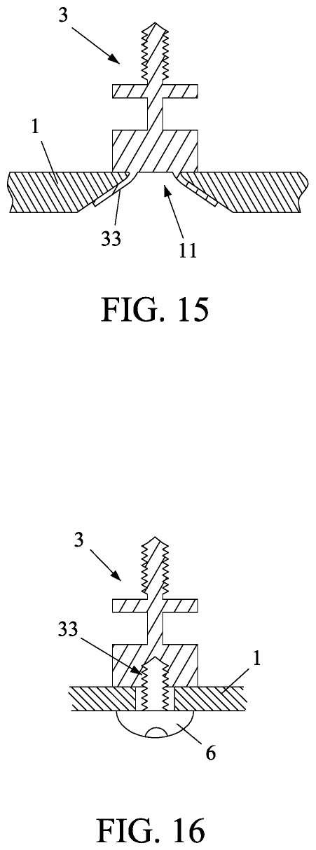

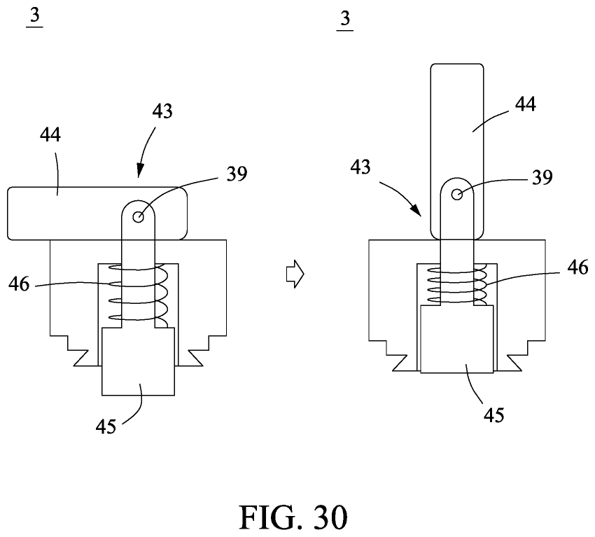

A fastener structure 3 is provided according to an embodiment of the present invention. The fastener structure 3 includes the anti-rotation portion 34 and the assembly portion 33. In this embodiment, the assembly portion 33 is the engaging portion 31. However, the present disclosure is not limited to the above example. The assembly portion 33 may also be a rivet connection portion (as in FIG. 29), an expansion connection portion (as in FIG. 15), a weld connection portion (as in FIG. 13), a lock connection portion (as in FIG. 16), an elastic fastening portion (as in FIG. 30), or other structures.

A method of use of a fastener structure is provided according to an embodiment of the present invention. The method uses the fastener structure 3 of the aforementioned embodiments to arrange the second object 2 on the first object 1. The method includes assembling the fastener structure 3 to the first object 1; simultaneously generating an anti-rotation effect between the anti-rotation portion 34 and the first object 1; and fitting the second object 2 in a direction defined or limited by the direction limiting portion 32 into the engaging portion 31.

A method of use of a fastener structure is provided according to an embodiment of the present disclosure, and the method uses the fastener structure 3 of the aforementioned embodiments to arrange the second object 2 on the first object 1. The method includes assembling the assembly portion 33 to the first object 1; simultaneously generating an anti-rotation effect between the anti-rotation portion 34 and the first object 1; and fitting the second object 2 in a direction defined or limited by the direction limiting portion 32 into the engaging portion 31.

A method of use of a fastener structure is provided according to an embodiment of the present disclosure, and the method uses the fastener structure 3 of the aforementioned embodiments to arrange the second object 2 on the first object 1. The method includes assembling the fastener structure 3 to the first object 1; and fitting the second object 2 in a direction defined or limited by the direction limiting portion 32 into the engaging portion 31.

Thus, the fastener structure 3 and the method of use thereof of the present disclosure are capable of quickly and simply arranging the second object 2 on the first object 1 and removing the second object 2 from the first object 1 in a predetermined direction. The second object 2 fitted into the engaging portion 31 may be a printed circuit board (PCB), a PCB with a copper layer, an iron board, a plastic board, or a metal board.

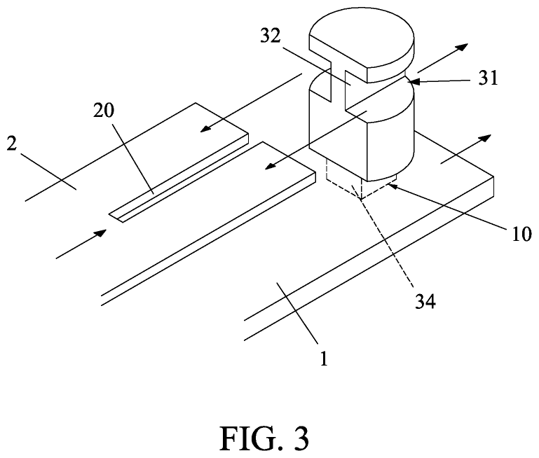

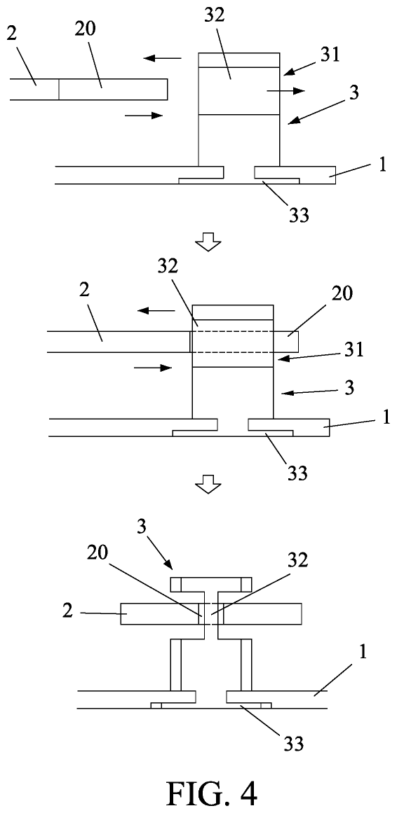

As shown in FIG. 3 to FIG. 4, in an embodiment, the direction limiting portion 32 is a structure capable of limiting a linear movement of the second object 2 fitted into the engaging portion 31. For example, the direction limiting portion 32 is a long slide channel, and the second object 2 has a passage 20 for fitting into the engaging portion 31. The direction limiting portion 32 may be included in the engaging portion 31. For example, a notch may be provided on each of both sides of the fastener structure 3 to form the engaging portion 31, and the direction limiting portion 32 may be a wall of the fastener structure 3 between the two notches. It should be noted that the present disclosure is not limited to the above examples.

As shown in FIG. 1 and FIG. 3, the anti-rotation portion 34 may be included in the assembly portion 33; that is, the anti-rotation 34 and the assembly portion 33 together may be regarded as an assembly structure having an anti-rotation function. The anti-rotation portion 34 may be an encircling side surface or one of the side surfaces of the assembly portion 33, such that the assembly portion 33 of the fastener structure 3 is in a non-circular form, and the first object 1 may correspondingly have a corresponding anti-rotation portion 10, for example, an opening. The corresponding anti-rotation portion 10 is used for anti-rotation against the anti-rotation portion 34. For example, the anti-rotation portion 34 provides the assembly portion 33 of the fastener structure 3 with a polygonal form. It should be noted that the present disclosure is not limited to the above examples. For example, the anti-rotation portion 34 may also provide the assembly portion 33 of the fastener structure 3 with a toothed form.

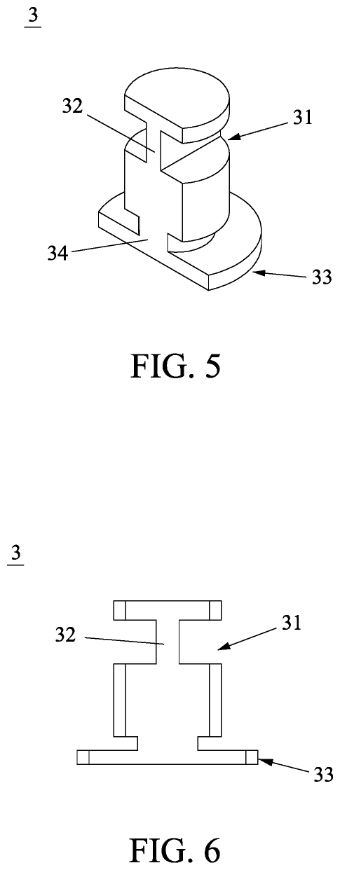

As shown in FIG. 5 and FIG. 6, in one embodiment, the anti-rotation portion 34 may provide the assembly portion 33 with a form having a trimmed edge. In other conceivable embodiments that are not depicted, the anti-rotation portion 34 may also provide the assembly portion 33 with an inwardly indenting or outwardly protruding form.

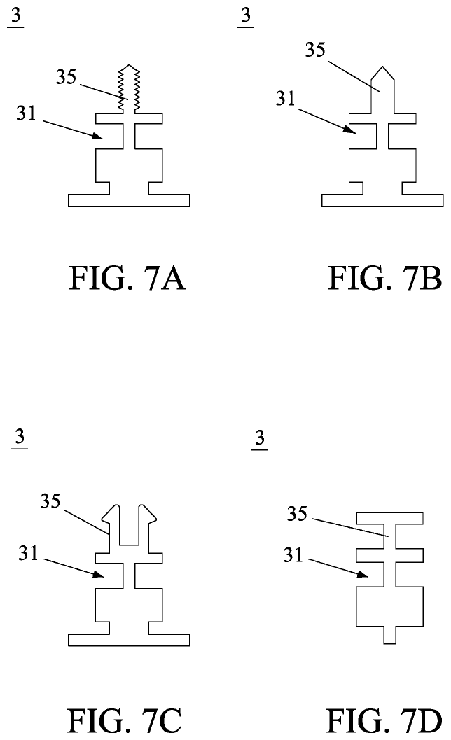

As shown in FIG. 7A to FIG. 7D, in some embodiments, the fastener structure 3 may further include a secondary fastening portion 35. The secondary fastening portion 35 may be a thread (as in FIG. 7A), a column (as in FIG. 7B), an elastic fastener (as in FIG. 7C), or a protruding fastener (as in FIG. 7D), so as to be engaged with other objects. However, the present disclosure is not limited to the above examples. The secondary fastening portion 35 may also be a fastener, an elastic body, or a recessed fastener.

As shown in FIG. 13 and FIG. 14, the assembly portion 33 may have a weldable surface 331, which is adapted to be heated and fixed to the first object 1 via a solder layer 4. The solder layer 4 may be located between the anti-rotation portion 34 and the corresponding anti-rotation portion 10. The corresponding anti-rotation 10 may be provided with a copper layer 5 for adhering to the solder layer 4. More specifically, a surface of the solder layer 4 heated and fixed to the first object 1 is fixed with the assembly portion 33, or the solder layer 4 is heated and fixed in a through hole of the first object 1 and is fixed with the assembly portion 33.

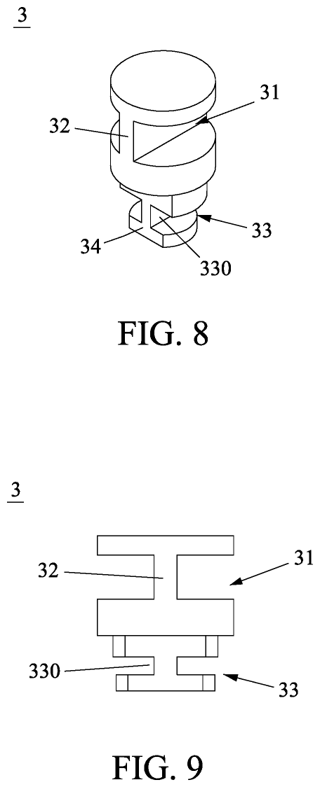

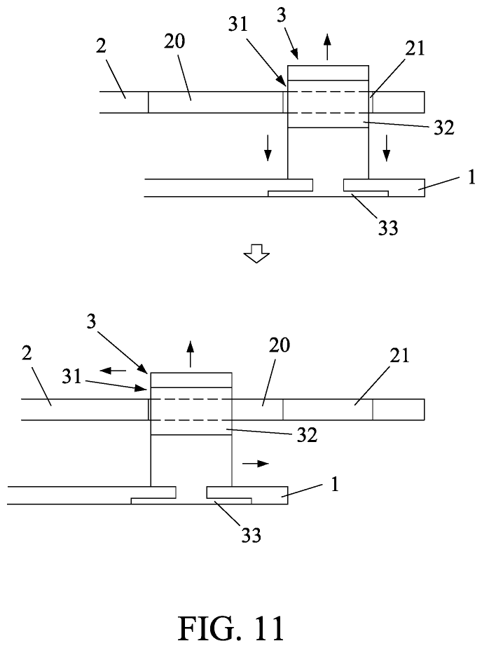

As shown in FIG. 8 to FIG. 11, in an embodiment, the second object 2 fitted into the engaging portion 31 has an entrance portion 21 and a passage 20 in communication with the entrance portion 21 or other corresponding structures. The fastener structure 3 is adapted to be received by the engaging portion 31 from the entrance portion 21, and then enter the passage 20 by the direction limiting portion 34. The entrance portion 21 may be an opening having a width greater than that of the passage 20. More specifically, the aperture of the entrance portion 21 is greater than the width of the engaging portion 31, the width of the engaging portion 31 is greater than the aperture of the passage 20, and the aperture of the passage 20 approximates to the width of the direction limiting portion 34 but is slightly greater than the width of the direction limiting portion 34, allowing entering of the direction limiting portion 34.

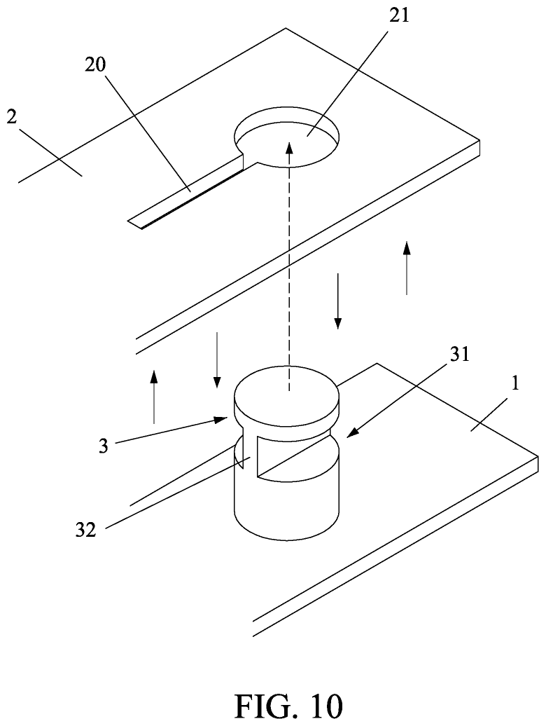

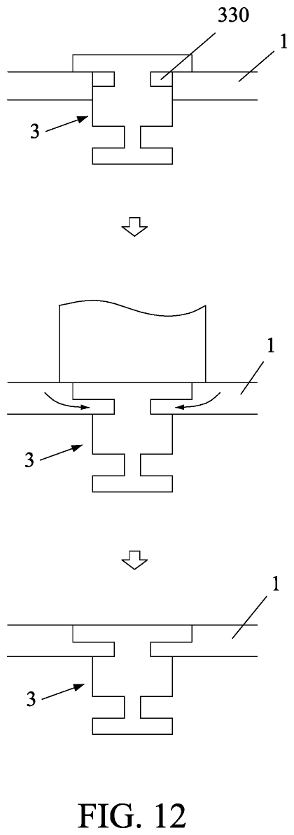

As shown in FIG. 8, FIG. 9, and FIG. 12, in an embodiment, the assembly portion 33 may have a feed space 330, and is adapted to apply an external force on the first object 1, so that the material of the first object 1 flows into or enters the feed space 330, thereby assembling the fastener structure 3 by means of rivet connection at the first object 1. However, means for assembling the fastener structure 3 to the first object 1 is not limited to the above example.

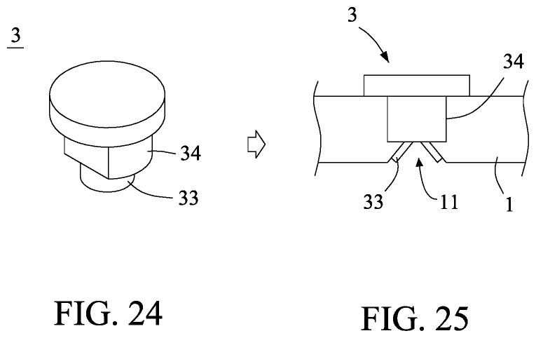

As shown in FIG. 15, in one embodiment, the assembly portion 33 is adapted to be assembled by means of expansion connection to the first object 1. The assembly portion 33 may be an expansion connection portion, and the first object 1 may have an expansion connection hole 11. As shown in FIG. 24 and FIG. 25, the fastener structure 3 may be first provided with an anti-rotation effect against the first object 1 by the anti-rotation portion 34, and then be expansion connected to the expansion connection hole 11 of the first object 1 by the assembly portion 33 that is an expansion connection portion.

As shown in FIG. 16, in one embodiment, the assembly portion 33 is adapted to be assembled by means of lock connection to the first object 1. The assembly portion 33 may be a screw hole, and is locked to the first object 1 in coordination with a screw 6. However, the present disclosure is not limited to the above example. For example, the assembly portion 33 may also be fittingly connected or elastically fittingly connected to the first object 1.

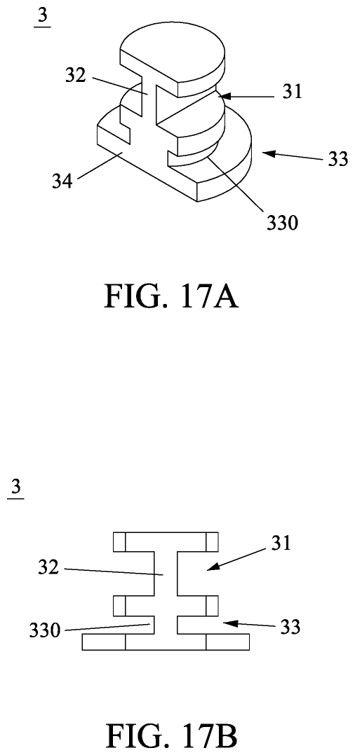

As shown in FIG. 17A and FIG. 17B, compared to the fastener structure 3 in FIG. 8, the fastener structure 3 in FIG. 17A and FIG. 17B has an assembly portion 33 and the feed space 330 have larger volumes so as to correspond to the first object 1 having a different structure.

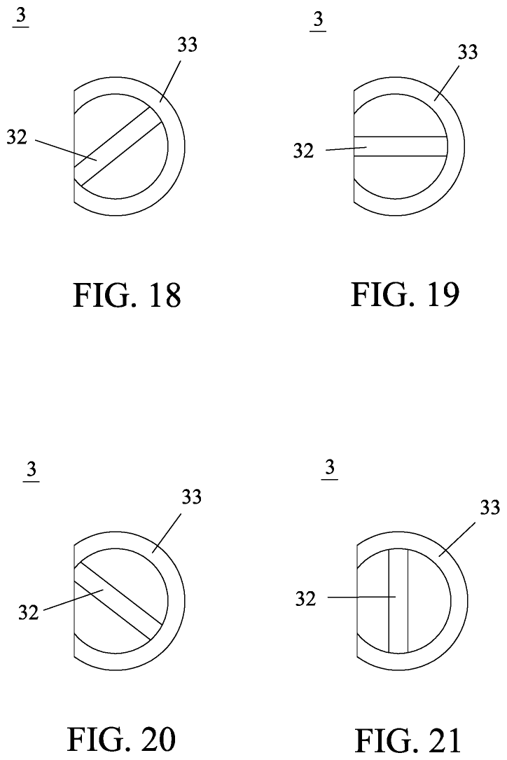

Referring to FIG. 18 to FIG. 21 as well as FIG. 3, in an embodiment, when the fastener structure 3 is assembled to the first object 1, the second object 2 fitted into the engaging portion 31 is adapted to be limited in any direction in a 360-degree plane by the direction limiting portion 32. For example, in FIG. 18 and FIG. 20, the direction limiting portion 32 allows the second object 2 to be at an inclined angle in the plane; in FIG. 19, the direction limiting portion 32 allows the second object 2 to be at a horizontal angle in the plane; and in FIG. 21, the direction limiting portion 32 allows the second object 2 to be at a vertical angle in the plane. However, the present disclosure is not limited to the above examples. When the fastener structure 3 is assembled to the first object 1, the second object 2 fitted into the engaging portion 31 may also be adapted to be limited in any direction in a three-dimensional space by the direction limiting portion 32.

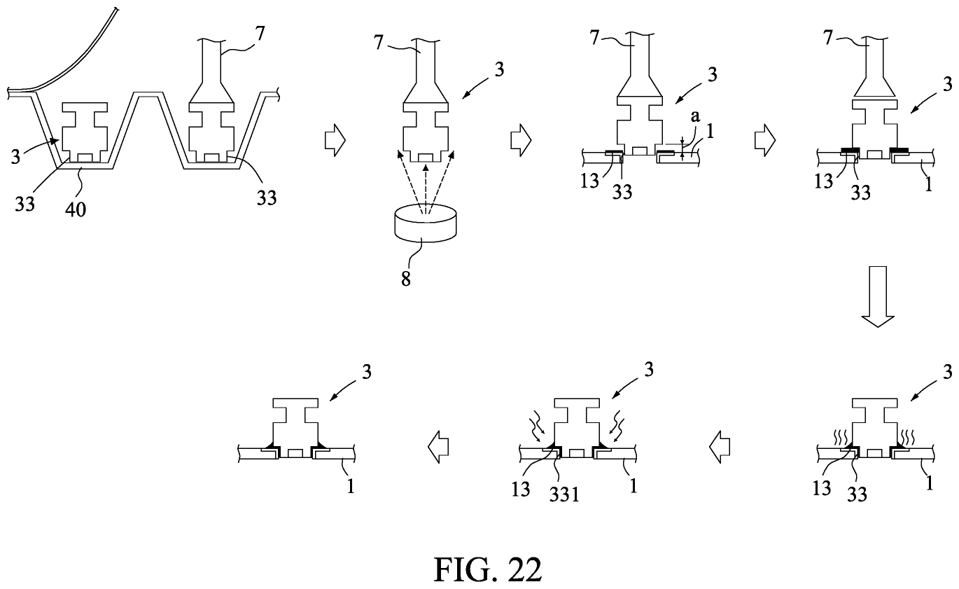

Referring to FIG. 22, in another aspect of the present disclosure, a method for assembling the fastener structure 3 to the first object 1 is provided. Before being assembled to the first object 1, the fastener structure 3 may be placed in a carrier 40. The fastener structure 3 has the foregoing weldable surface 331 used for arranging solder and has a fastening portion passing through, and an assembly position of the first object 1 has a corresponding weldable surface 13. The method includes the steps of: providing a tool 7 to pick up the fastener structure 3 from the carrier 40; using the tool 7 to move the fastener structure 3 to a predetermined height a above the assembly position (that is, the through hole) of the first object 1; and releasing or setting free the fastener structure 3 from the tool 7, so that the fastener structure 3 drops and becomes placed at the assembly position of the first object 1. Thus, the fastener structure 3 can be fixed to the first object 1 to improve efficiency of subsequent processes. The tool 7 may be a clamp, a fixture, a vacuum suction device, a magnetic suction device, or an elastic motion element in order to meet actual assembly requirements.

In an embodiment, after the fastener structure 3 is picked up by the tool 7 from the carrier 40, a comparison device 8 may compare the fastener structure 3 with a position or a distance of the corresponding weldable surface 13 of the assembly position of the first object 1, so that the tool 7 moves the fastener structure 3 to the predetermined height a (for example, 0.000001 mm to 10 mm) above the corresponding weldable surface 13 of the first object 1 according to the comparison information of the comparison device 8 and releases or sets free the fastener structure 3, so that the fastener structure 3 drops to the assembly position of the first object 1 and the weldable surface 331 is joined to the corresponding weldable surface 13. Then, the weldable surface 331 and the corresponding weldable surface 13 are heated and welded to have the fastener structure 3 be welded to the first object 1. In an embodiment, the comparison device 8 may be a vision comparison device, a distance comparison device, an image comparison device, an AI comparison device, or a camera comparison device in order to meet actual assembly requirements.

In an embodiment, if the first object 1 does not have the corresponding weldable surface 13 and the fastener structure 3 does not have the weldable surface 331, after the comparison device 8 compares the fastener structure 3 with the assembly position or the assembly distance of the first object 1, the tool 7 may directly drop the fastener structure 3 onto the assembly position of the first object 1.

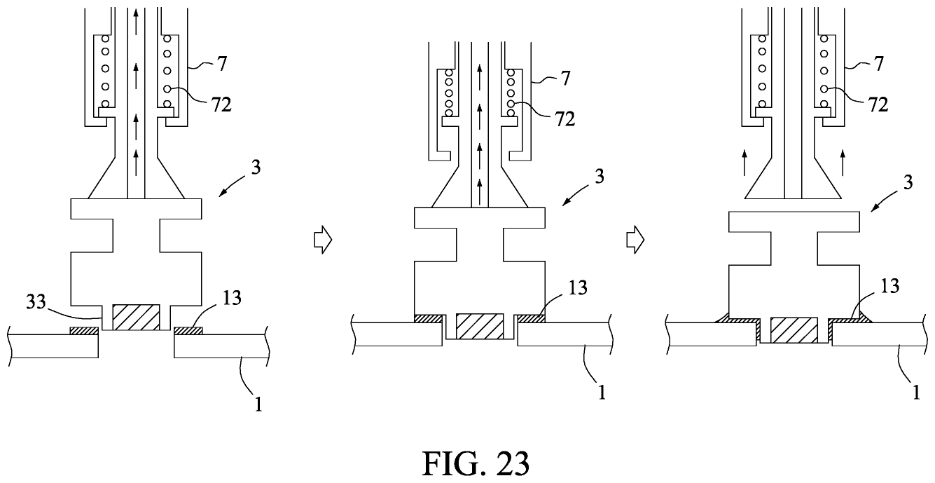

Referring to FIG. 23, in one embodiment, the tool 7 may provide a vacuum suction force, and may be provided with an elastic element 72 therein. The elastic element 72 in coordination with the vacuum suction force causes the tool 7 to pick up the fastener structure 3. The tool 7 may move the fastener structure 3 to the assembly position of the first object 1, and elastically press the fastener structure 3 downward toward the first object 1 by compressing the elastic element 72. Moreover, a stop member may be provided at the bottom of the fastening portion of the fastener structure 3 to prevent liquidized solder from flowing into the fastening portion. Once the fastener structure 3 is located at the assembly position of the first object 1, the vacuum suction force of the tool 7 is terminated and the elastic element 72 is elastically reset, so that the tool 7 releases or sets free the fastener structure 3, and the fastener structure 3 becomes placed at the assembly position of the first object 1. Once the solder of the weldable surface 331 is cooled and the fastener structure 3 is thus fixed with the first object 1, the stop member may be removed to restore the assembly effect of the fastening portion, so as to meet subsequent assembly requirements. However, the tool 7 may exclude the elastic element 72 and only presses the fastener structure 3 downward toward the first object 1, or the fastener structure 3 is released or set free by the tool 7, so that the fastener structure 3 becomes placed at the assembly position.

As described above, the fastener structure 3 is capable of quickly being assembled on the first object 1, and therefore the assembly method of the fastener structure 3 of the present disclosure is also capable of subsequently quickly and simply arranging the second object 2 on the first object 1 and removing the second object 2 from the first object 1 in a predetermined direction as described in the foregoing embodiments.

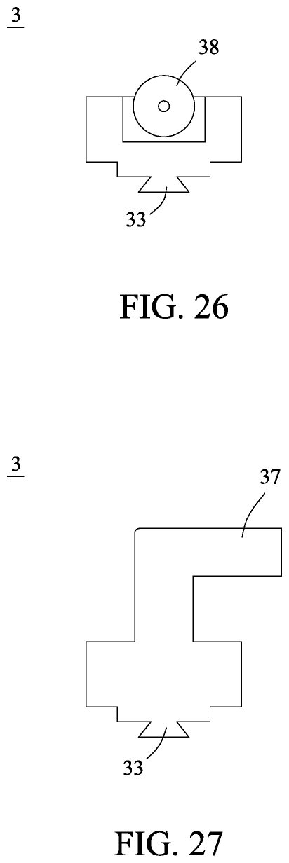

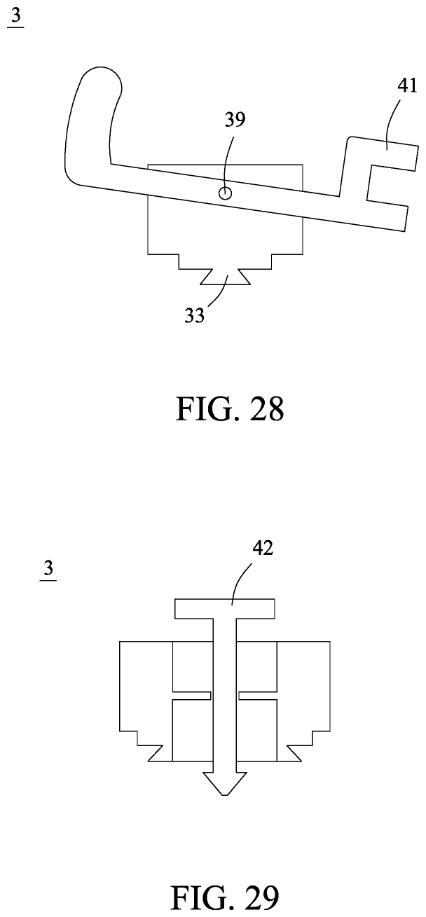

As shown in FIG. 26 to FIG. 30, in addition to including the assembly portion 33 that is an engaging portion, the fastener structure 3 may further include a handle portion 37 (as in FIG. 27). The fastener structure 3 may also be rotatably connected to a wheel member 38 (as in FIG. 26) by a shaft 39. The fastener structure 3 may also be installed with an auxiliary push member 41 (as in FIG. 28) by the shaft 39. The fastener structure 3 may also be installed with another fastener 42 (as in FIG. 29), which may pass through the fastener structure 3 so as to be engaged with another object (not shown). In FIG. 30, the fastener structure 3 may also be installed with a secondary fastening member 43 having a rotating body 44. The secondary fastening member 43 includes the rotating body 44 and a fastening portion 45 pivotally connected to the rotating body 44. The rotating body 44 is located on a top surface of the fastener structure 3, and the fastening portion 45 is located in the fastener structure 3 and can be extend out of or withdrawn into the fastener structure 3 due to the action of the rotating body 44 so as to be engaged with another object. A fastening elastic element 46 may abut between the fastening portion 45 and the fastener structure 3, so that the fastening portion 45 can be elastically ejected when the rotating body 44 rotates to a predetermined angle. However, the present disclosure is not limited to the above examples. For example, the assembly portion 33 may also be an engaging portion, as the engaging portion 31 shown in FIG. 1 to FIG. 4.

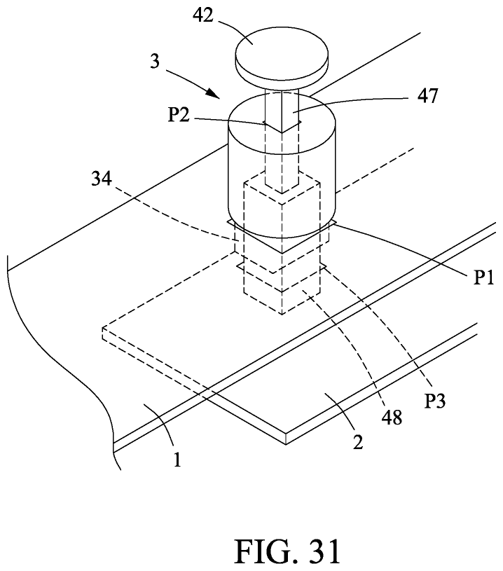

As shown in FIG. 31, the secondary fastener 42 includes both a fastener anti-rotation portion 47 and a secondary anti-rotation portion 48, so as to provide the fastener structure 3 and another object (for example, the second object 2) with an anti-rotation or limiting effect; however, the present disclosure is not limited to the above examples. The secondary fastener 42 may include only the fastener anti-rotation portion 47 so as to provide the fastener structure 3 with an anti-rotation or limiting effect. The secondary fastener 42 may include only the secondary anti-rotation portion 48 so as to provide another object with an anti-rotation or limiting effect. The first object 1 may include a first corresponding anti-rotation portion P1 used for anti-rotation against the anti-rotation portion 34. The fastener structure 3 may include a second corresponding anti-rotation portion P2 used for anti-rotation against the fastener anti-rotation portion 47. The second object 2 may include a third corresponding anti-rotation portion P3 used for anti-rotation against the secondary anti-rotation portion 48. The anti-rotation portion 34, the fastener anti-rotation portion 47 and the secondary anti-rotation portion 48 may be non-circular bodies, and are, for example, polygonal bodies. The first corresponding anti-rotation portion P1, the second corresponding anti-rotation portion P2, and the third corresponding anti-rotation portion P3 may be non-circular openings or through holes having corresponding shapes.

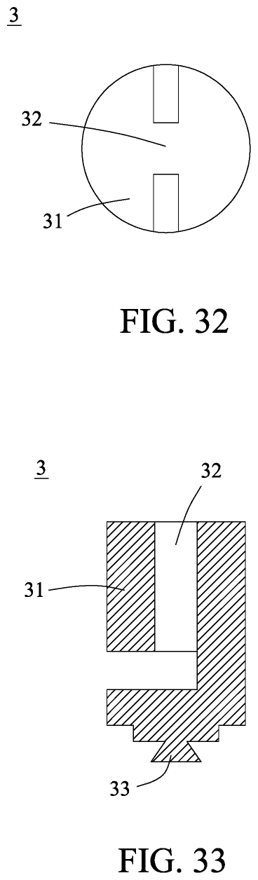

As shown in FIG. 32 and FIG. 33 as well as referring to FIG. 3, the direction limiting portion 32 of the fastener structure 3 is capable of limiting the angle between the movement direction of the second object 2 and the assembly portion 33. In this embodiment, the movement direction of the second object 2 is limited to be perpendicular to the assembly portion 33. However, the present disclosure is not limited to the above example. The direction limiting portion 32 may also limit the movement direction of the second object 2 to be horizontal to the assembly portion 33, or to an angle that is neither perpendicular nor horizontal to the assembly portion 33.

The present disclosure is described by way of the preferred embodiments above. A person skilled in the art should understand that, these embodiments are merely for describing the present disclosure are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. A fastener structure, for arranging a second object on a first object, the fastener structure comprising:
an engaging portion, for engaging the second object;
a direction limiting portion, connected to the engaging portion and for limiting a movement direction of the second object engaged with the engaging portion; and
an assembly portion, for assembling to the first object;
wherein the second object fitted into the engaging portion has an entrance portion and a passage in communication with the entrance portion, and the fastener structure is adapted to be received by the engaging portion from the entrance portion and then enter the passage by the direction limiting portion.

2. A fastener structure, for arranging a second object on a first object, the fastener structure comprising:
an engaging portion, for engaging the second object;
a direction limiting portion, connected to the engaging portion and for limiting a movement direction of the second object engaged with the engaging portion; and
an anti-rotation portion, for preventing the fastener structure from rotating relative to the first object;
wherein the second object fitted into the engaging portion has an entrance portion and a passage in communication with the entrance portion, and the fastener structure is adapted to be received by the engaging portion from the entrance portion and then enter the passage by the direction limiting portion.

3. The fastener structure according to claim 1, wherein the entrance portion is greater than the engaging portion, the engaging portion is greater than the passage, and the passage is greater than the direction limiting portion.

4. The fastener structure according to claim 2, wherein the entrance portion is greater than the engaging portion, the engaging portion is greater than the passage, and the passage is greater than the direction limiting portion.

5. The fastener structure according to claim 1, wherein the direction limiting portion is for limiting a movement direction of the second object to be horizontal or perpendicular to an assembly portion, or to an angle that is neither perpendicular nor horizontal.

6. The fastener structure according to claim 2, wherein the direction limiting portion is for limiting a movement direction of the second object to be horizontal or perpendicular to an assembly portion, or to an angle that is neither perpendicular nor horizontal.

7. A fastener structure, for arranging a second object on a first object, the fastener structure comprising:
an engaging portion, for engaging the second object;
a direction limiting portion, connected to the engaging portion and for limiting a movement direction of the second object engaged with the engaging portion; and
an assembly portion, for assembling to the first object;
wherein the fastener structure installed with a secondary fastener, the secondary fastener has a fastener anti-rotation portion, which provides the fastener structure with an anti-rotation or limiting effect; or the secondary fastener has another anti-rotation portion, which provides another object with an anti-rotation or limiting effect.

8. A fastener structure, for arranging a second object on a first object, the fastener structure comprising:
an engaging portion, for engaging the second object;
a direction limiting portion, connected to the engaging portion and for limiting a movement direction of the second object engaged with the engaging portion; and
an anti-rotation portion, for preventing the fastener structure from rotating relative to the first object;
wherein the fastener structure installed with a secondary fastener, the secondary fastener has a fastener anti-rotation portion, which provides the fastener structure with an anti-rotation or limiting effect; or the secondary fastener has another anti-rotation portion, which provides another object with an anti-rotation or limiting effect.
